(19) United States
(12) Patent Application Publication
(10) Pub. No.: US 2015/0127211 A1
(43) Pub. Date: May 7, 2015

(54) Measuring System and Data Processing Infrastructure

(71) Applicant: MUELLER-BBM Vibroakustik Systeme GMBH, Planegg (DE)

(72) Inventor: Josef Hobelsberger, Munich (DE)

(21) Appl. No.: 14/397,928

(22) PCT Filed: May 2, 2013
(86) PCT No.: PCT/EP2013/059158

§ 371 Date: Oct. 30, 2014

(30) Foreign Application Priority Data
May 8, 2012 (DE) 10 2012 207 597.6

(51) Int. Cl. G07C 5/08; H04Q 9/00; G07C 5/00; G01D 21/00

(52) U.S. Cl. CPC G07C 5/0841; G01D 21/00; H04Q 9/00; G07C 5/008; H04Q 2209/30; H04Q 2209/43
USPC 701/31.5

(57) ABSTRACT

The present invention relates to a measuring system for detecting measurement data, particularly for detecting measurement data in a vehicle, comprising a measuring device which has a first network interface that is designed at least to couple the measuring system to a data processing infrastructure, and a first coupling device that is designed, if a coupling exists, to couple the measuring system to the data processing infrastructure non-transparently as a component of the data processing infrastructure and/or to couple the measuring device non-transparently via the first network interface to an additional measuring device to form a single coupled measuring device. The present invention further relates to a data processing infrastructure comprising such a measuring system.

### FIELD OF THE INVENTION

The present invention relates to a measuring system for acquiring measurement data, in particular for acquiring measurement data in a vehicle. The present invention further relates to a data processing infrastructure.

### TECHNICAL BACKGROUND

Systems for acquiring data, in particular measurement data, are today used in numerous applications. For example, systems for acquiring measurement data can be used in the development of motor vehicles, aircraft or the like. In these applications, sensors for detecting measurement data are normally connected to a memory, which stores the measurement data detected by the sensors. In vehicle development, for example, high-precision acceleration sensors and angular rate sensors as reference sensors can support the development of electronic vehicle stabilisation systems (for example ESP systems). In such systems, the data from the sensors in the electronic system and the data from the reference sensors are captured and stored in the memory.

Acquisition units used today normally store the data from the system sensors and the reference sensors for subsequent processing. Such acquisition units store the data, for example, on an SD memory card or a hard disk, and transfer these data to a PC via a USB port.

Such acquisition units are usually also adapted to the given measurement task and comprise the sensor connectors suitable for the given measurement task. For example, an acquisition unit that is being used for developing stability systems in a vehicle can comprise connectors for acceleration sensors and motion sensors. On the other hand, if an acquisition unit is being used in the optimisation of vehicle noise and/or vibration properties, it may also comprise, for example, connectors for vibration sensors and acoustic sensors.

For the purpose of further processing, the measurement data are usually transferred to a computer, for example a Windows PC, and analysed there by suitable software systems. The software systems that analyse the measurement data are normally different for the different measurement tasks. Standard analysis of the measurement data captured for different measurement tasks is not provided.

### SUMMARY OF THE INVENTION

Against this background, the object of the present invention is to enable simpler acquisition, handling and analysis of measurement data.

This object is achieved according to the invention by a measuring system having the features of claim 1 and by a data processing infrastructure having the features of claim 13.

It is accordingly provided that:
the present invention relates to a measuring system for acquiring measurement data, in particular for acquiring measurement data in a vehicle, which measuring system comprises a measuring device comprising: a first network interface, which is designed at least to connect the measuring system to a data processing infrastructure, and a first connection device, which is designed to connect the measuring system, when a connection to the data processing infrastructure exists, non-transparently to the data processing infrastructure as a component thereof, and/or to connect the measuring device via the first network interface to a further measuring device non-transparently to form an individual connected measuring device; and to
a data processing infrastructure comprising at least two processing devices, each of which comprises a second network interface, wherein the second network interface is designed to connect the processing devices to one another, comprising a second connection device, which is designed to connect the processing devices non-transparently to form a connected processing device, comprising a communications interface, which is designed to connect the connected processing device to at least one measuring system according to the invention, and comprising a second control device, which is designed to identify and/or authenticate automatically a measuring system on connection of the measuring system to the data processing infrastructure.

The present invention is based on the realisation that different measurement tasks are not solved in a standard manner in previous measuring systems. Bearing in mind this realisation, the concept that forms the basis of the present invention is to provide a facility for handling different measurement tasks in a standard manner and to prepare and present the results of the measurement tasks in a standard manner.

For this purpose, the present invention provides a measuring device that can connect itself to an existing data processing infrastructure. The measuring device connects itself to the data processing infrastructure in a manner that it is non-transparent to a user such that it appears as an integral part of the data processing infrastructure.

The measuring device according to the invention forms with the data processing infrastructure a computer network, nowadays referred to, for example, as a “digital cloud”. If an element of the data processing infrastructure, for example a measuring device, can dynamically connect itself to the data processing infrastructure and disconnect itself therefrom, this is also referred to as an “ad-hoc cloud”. An example of this is the case in which a measuring device is installed in a vehicle that is on a test drive during which there is no opportunity to connect the measuring device to the data processing infrastructure via a data network. If such a test drive spans several days, for example, a network connection may be available in a hotel in the evening of a test day. Then at the end of a test day, for example, a developer can establish the connection between the measuring device and the data processing infrastructure via the hotel network connection.

The measuring device is also designed to integrate itself into the data processing infrastructure non-transparently. This means that access to the measuring device cannot be distinguished from access to the data processing infrastructure. If a user accesses such a measuring device or such a data processing infrastructure, it is hence not apparent to this user whether access is being made to the individual measuring device or the data processing infrastructure.

The present invention further provides that a measuring device is able to connect itself to further measuring devices to form a connected measuring device, effectively forming a network, and to handle measurement tasks jointly. It is provided here that the measuring devices are networked together non-transparently in such a way that a user can access any measuring device in the network and perceives the network as an individual measuring device during access. In this context, the term “local cloud” can be used, for example. Hence a connection device according to the invention can be used, for example, to connect a plurality of measuring devices in a vehicle to one another.

Finally, the present invention provides a data processing infrastructure that can be connected to one or more measuring devices according to the invention so as to allow data communication. The data processing infrastructure is designed in this case to identify and/or authenticate the measuring devices on connection to the data processing infrastructure. It is thereby possible to ensure that only measuring devices belonging to a company that operates the data processing infrastructure, for example, gain access to the data processing infrastructure.

Advantageous embodiments and developments of the invention appear in the subclaims and in the description with reference to the drawings.

In one embodiment, the measuring device comprises a first control device, which is designed to transmit acquired measurement data automatically to the data processing infrastructure when a connection to the data processing infrastructure exists. This enables a plurality of users to access the acquired data soon after the data are acquired.

Additionally or alternatively, the first control device is designed to transmit, when a connection to the data processing infrastructure exists, the acquired measurement data to the data processing infrastructure in response to a request from the data processing infrastructure. It is thereby possible to provide acquired data very rapidly in the data processing infrastructure. It also enables data to be retrieved, for example at specified time intervals. In addition, data acquired in a data acquisition device can be transferred to the data processing infrastructure in a one-off transfer, for example when the network load is low. This allows the acquired data to be provided to a plurality of users without permanently loading a data network that connects the data processing infrastructure to data acquisition devices.

In one embodiment, the measuring device comprises a user interface, which is designed to provide access to the measuring device for a user. The user interface, for example, can be in the form of a touchscreen monitor, a monitor combined with a mouse and/or keyboard or in the form of an application interface or access interface, for example a Web interface. This enables very easy access to the measuring device and hence to the data processing functions and/or the acquired measurement data.

In one embodiment, the user interface is designed to provide access for a user to data processing functions of the measuring device, wherein the data processing functions provided to the user constitute at least a subset of a set of data processing functions provided to the user by the data processing infrastructure. It is thereby possible to provide for a user at least some of those data processing functions that a data processing infrastructure can provide to a user, even when the user only has access to a measuring device. In particular, the user can be provided with those data processing functions that correspond to the measurement task performed by the measuring device concerned.

For example, such a measurement task may be the acquisition of acoustic and vibration quantities in a vehicle powertrain. In such a case, the user can be provided with data processing functions, for example, that enable the visualisation, audible output, frequency analysis or the like of the acquired acoustic and vibration quantities.

It is also possible that the measuring device concerned having no connection to a data processing infrastructure computes at least some of the data processing functions autonomously and promptly provides the results of the computation to a user.

In one embodiment, the user interface is designed to provide, when a connection to the data processing infrastructure exists, access for the user to all the data processing functions that the data processing infrastructure provides to the user, wherein the user interface is designed, for those data processing functions that are not provided directly on the measuring device, to transfer the request of the user, in particular in a manner that is non-transparent to the user, to the data processing infrastructure, and to receive from the data processing infrastructure the results from the relevant data processing functions and transfer these results to the user. This enables a user to access all the data and data processing functions of the data processing infrastructure when a connection exists between the measuring device concerned and the data processing infrastructure. It further enables a user, for example, to compare measurement data that this user has acquired in a measurement task with the measurement data from another user or with measurement data that this user has captured in a previous measurement. It also enables the user to combine the acquired measurement data with other measurement data in order to perform, for example, special analyses on a vehicle.

In one embodiment, the user interface is designed to provide, on connection of the measuring device to at least one further measuring device in the connected measuring device, non-transparent access for a user to all the data processing functions provided by the measuring devices connected in the connected measuring device. This enables easy access to all the measuring devices connected to one another in a connected measuring device without a user having to have specific knowledge about the individual measuring devices. It is thereby also possible to provide to a user the data processing functions, and hence also the data, of all the measuring devices via a common interface. A user does not need to know which of the measuring devices to interact with, but can access the required functions directly via the connection device.

In particular, this also means that the connected measuring device can expand to include further measuring devices. A user can then access the expanded connected measuring device via the user interface without further configurations being needed to the connected measuring device.

In one embodiment, the measuring device comprises a sensor interface, which is designed to acquire measurement data from at least one sensor. This enables different measuring devices to be designed for different tasks. For example, one measuring device can comprise a sensor interface that is designed to capture data from sound-pressure sensors, and another measuring device can comprise a sensor interface that is designed to capture data from acceleration sensors or position sensors.

In one embodiment, at least one of the measuring devices comprises a data processing device, which is designed to provide data processing functions for the acquired measurement data. Instead of a sensor interface, for example, this data processing device can be equipped with processing devices with high processing power, and can compute the data processing tasks in place of the other measuring devices. In one embodiment, a measuring device comprises a sensor interface and a data processing device.

In one embodiment, the measuring device comprises an adaption device, which is designed to adapt according to the predefined access rights the function that the measuring device provides as a component of the data processing infrastructure and/or of the connected measuring device to the data processing infrastructure and/or to the connected measuring device. It is thereby possible to restrict the computations performed in a measuring device to those computations to which the user has access according to the access rights of said user.

In one embodiment, the second control device is designed to integrate the measuring device into the data processing infrastructure non-transparently as a component thereof when a connection exists between the data processing infrastructure and a measuring device. This enables integration of a plurality of measuring devices into the data processing infrastructure without a user noticing a difference between working with a measuring device or the data processing infrastructure. This enables standard use of the measuring devices or data processing functions provided to the data processing infrastructure.

In one embodiment, the data processing infrastructure is designed to retrieve at specified times, measurement data acquired by the measuring devices. This enables data to be retrieved, for example, at specified time intervals. Data acquired in a data acquisition device can also be transferred to the data processing infrastructure in a one-off transfer, for example when the network load is low. This allows the acquired data to be provided to a plurality of users without permanently loading a data network that connects the data processing infrastructure to data acquisition devices.

Additionally or alternatively, the data processing infrastructure is designed to retrieve measurement data acquired by the measuring devices on connection of one of the measuring devices to the data processing infrastructure. This enables acquired data to be provided very rapidly in the data processing infrastructure. This enables a plurality of users to access the acquired data soon after the data is acquired.

In one embodiment, the data processing infrastructure comprises an adaption device, which is designed to adapt according to predefined access rights, access to the data processing infrastructure for a user. It is thereby possible to provide to a user only those functions to which this user is meant to have access. This secures data against unauthorised access and also enables a clear display of the available data processing functions.

The above embodiments and developments can be combined with one another in any practical way. Further possible embodiments, developments and implementations of the invention also include combinations of features of the invention described above or below with regard to embodiments, even if these combinations are not mentioned explicitly. In particular, a person skilled in the art will also add individual aspects as improvements or additions to the relevant basic form of the present invention.

### CONTENTS OF THE DRAWINGS

The present invention is explained in greater detail below with reference to the embodiments given in the schematic diagrams of the drawings, in which:

FIG. 1 is a block diagram of an embodiment of a measuring device according to the invention;

FIG. 2 is a block diagram of an embodiment of a data processing infrastructure according to the invention;

FIG. 3 is a block diagram of a further embodiment of a data processing infrastructure according to the invention.

The accompanying drawings are intended to provide greater understanding of the embodiments of the invention. They illustrate embodiments and are used in conjunction with the description to explain principles and concepts of the invention. Other embodiments and many of the stated advantages are apparent from the drawings. The elements of the drawings are not necessarily shown to scale.

In all the figures, elements that are identical or have the same function are denoted by the same reference signs unless otherwise stated.

### DESCRIPTION OF EMBODIMENTS

In this document, the term measuring device is understood to mean an electronic system that is designed to capture and store measurement data from at least one sensor. In addition, the electronic system is designed to connect itself to a data processing infrastructure. Such a system can be implemented as an “embedded system”, for example, which comprises a processor, a sensor interface, a memory and a network interface. Such an “embedded system” can be operated, for example, by the operating system VxWorks, Linux or embedded Linux or a Windows derivative. SD cards or hard disks, in particular notebook hard disks because of their small size, can be used as the memory for example.

A data processing infrastructure is understood to mean in the context of this description a network of at least two computers, which network is able to capture the measurement data of the measuring devices and save this data and/or process this data further according to the predefined measurement tasks. The data processing infrastructure is also able to identify and, if required, authenticate individual measuring devices before these devices are connected to the data processing infrastructure.

A connection device is understood to be a device that is designed to connect measuring devices or even the computers of the data processing infrastructure to one another such that it is not apparent to a user whether the user is accessing an individual measuring device or an individual computer. Such a connection device can be designed, for example, as a software module of the operating system of the measuring device and/or the computers of the data processing infrastructure. The connection module can also be designed, however, as a hardware module, which is arranged in a data connection between the measuring devices and/or the computers of the data processing infrastructure. In such an embodiment, the connection device can be implemented, for example, as a switch or router with advanced function.

A non-transparent connection is understood to mean in this description a connection to one or more electronic systems, which connection is implemented such that it is not apparent to a user whether access is being made to a single electronic system or a plurality of interconnected electronic systems, for example measuring devices.

FIG. 1 is a block diagram of an embodiment of a measuring system 10 according to the invention comprising a measuring device 1.

The measuring device 1 comprises a first network interface 2, which is designed to connect the measuring system 10 to a data processing infrastructure 20, for example via a data network 30 (not shown in FIG. 1). Additionally or alternatively, the first network interface 2 is designed to connect the measuring device 1 to further measuring devices 1.

The first network interface 1 can be designed, for example, as a wired interface 2, for example as an Ethernet interface 2, as a fibre-optic interface 2 or as a wireless interface 2, for example as a WLAN, WIFI, WiMax interface 2 or the like. In one embodiment, the first network interface 2 transfers data using the TCP/IP protocol.

The measuring device 1 in FIG. 1 further comprises a connection device 3, which is connected to the first network interface 1. The connection device 1 is designed to perform the connection of the measuring system 10 to a data processing infrastructure 20 via the first network interface 2, or the connection of the measuring device 1 to further measuring devices 1.

The connection device 3 is designed in particular to perform the connection of the measuring system 10 to a data processing infrastructure 20 in such a way that the measuring device 1 is connected non-transparently to the data processing infrastructure 20 as a component thereof. Both the processing capacity and the data memory of the measuring device 1 or the data of the data processing infrastructure 20 saved therein are thereby added in a similar manner to a “cloud”.

In addition, the connection device 3 is designed to perform the connection of the measuring device 1 to further measuring devices 1 in such a way that the interconnected measuring devices 1 appear to be a single measuring device: a connected measuring device 4. In this case, like the connection of the measuring device 1 as a component of the data processing infrastructure 20, the processing capacities and the data memories of the individual measuring devices 1 or the data stored therein are provided jointly to the connected measuring device 4.

In further embodiments not shown in FIG. 1, the measuring device 1 can further comprise a first control device 5-1 to 5-4, for example a microprocessor 5-1 to 5-4, which is designed to transmit acquired measurement data from the measuring device 1 to the data processing infrastructure 20 via the first network interface 2. In this case, the microprocessor 5-1 to 5-4 can be designed to transmit the acquired measurement data automatically to the data processing infrastructure 20 when a connection exists between the measuring device 1 and the data processing infrastructure 20, or to transfer the acquired measurement data to the data processing infrastructure 20 only on request.

In one embodiment, the microprocessor 5-1 to 5-4 is further designed to perform the function of the connection device 3. In such an embodiment, the function of the connection device 3 is implemented, for example, as a software component in an operating software, for example an operating system, of the microprocessor 5-1 to 5-4. In addition, the function of transferring the acquired measurement data to the data processing infrastructure 20 can likewise be designed as a software module in the microprocessor 5-1 to 5-4.

In yet further embodiments not shown in FIG. 1, a measuring device 1 further comprises a sensor interface 7-1, 7-3, which connects the measuring device to a plurality of different sensors 8. For example, the sensor interface 7-1, 7-3 can comprise analog, digital and optical interfaces or the like, which can be connected to the individual sensors 8.

Finally, in yet further embodiments not shown in FIG. 1, a user interface 6-2, 6-4 and an adaption device can be provided in the measuring device 1. The user interface 6-2, 6-4 is used here to allow a user 11 access to the measuring device 1. In addition, however, the user interface 6-2, 6-4 is also used to adapt the access of the user 11 to the measuring device 1 according to the connection status of the measuring device 1.

If the measuring device 1 is connected, for example, to a data processing infrastructure 20, in one embodiment the user interface 6-2, 6-4 adapts the access to the measuring device 1 such that a user is granted access to all the data processing functions and data of the data processing infrastructure 20. If a user 11 then actually accesses, for example, a data processing function of the data processing infrastructure 20, then the user interface 6-2, 6-4 transfers the request of the user to the data processing infrastructure 20 and displays to the user the results computed by the data processing infrastructure 20. In this process, it is not apparent to the user whether the data processing task has been computed by the measuring device 1 or inside the data processing infrastructure 20.

In combination with the user interface 6-2, 6-4, in some embodiments an adaption device can be provided that adapts the access of a user 11 to the measuring device 1 according to the user rights of the user 11. In this case, for example, the access of the user 11 to data processing functions or data can be restricted. For example, a user can be allowed access only to the data and data processing functions of the workgroup of this user.

The user interface 6-2, 6-4 is not intended to be a physical user interface such as a touchscreen, for example. Instead, the user interface 6-2, 6-4 is intended to be an application interface or access interface, for example a Web interface or app. In one embodiment, the function of the user interface and the function of the adaption device can also be integrated at least in part as a program module in the first control device 5-1 to 5-4.

In one embodiment, the user interface 6-2, 6-4 is embodied as the user interface 6-2, 6-4 of the measuring system 10, which user interface is at a higher level than the measuring devices 1.

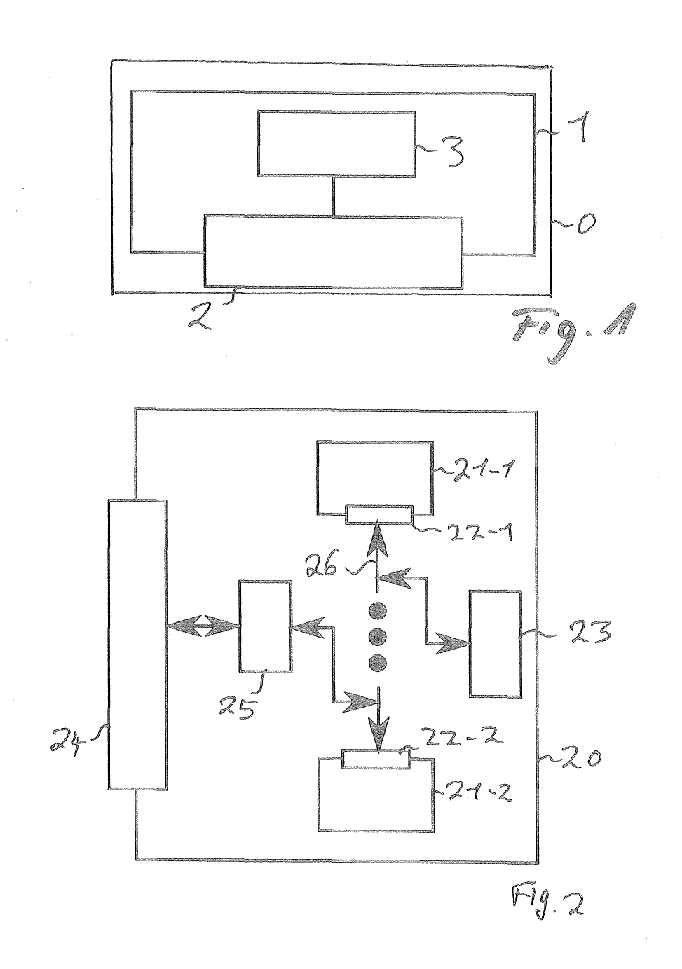

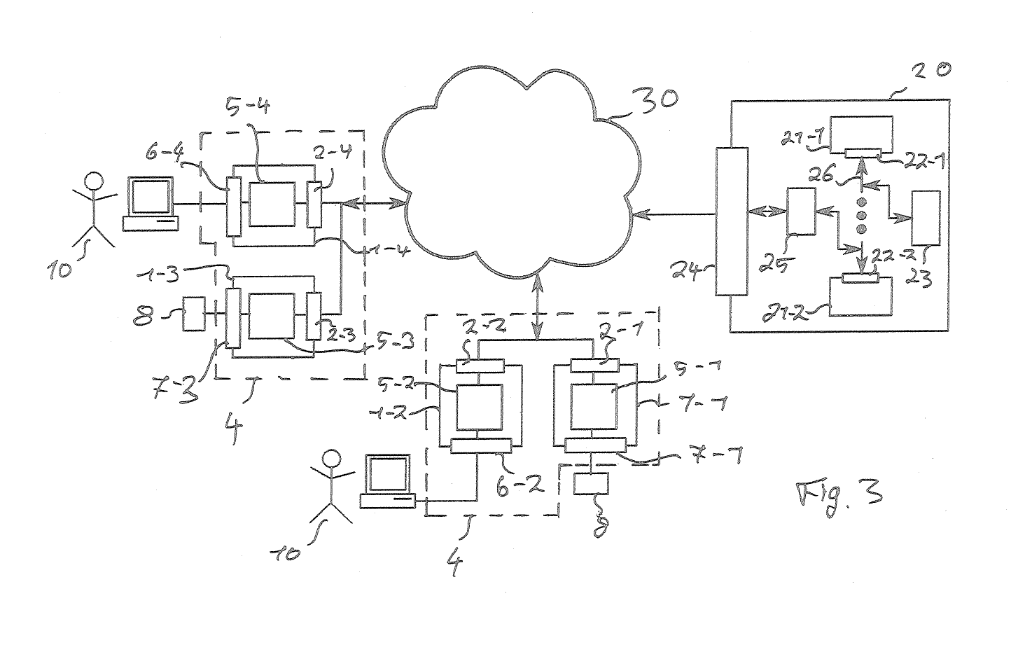

FIG. 2 is a block diagram of an embodiment of a data processing infrastructure 20 according to the invention.

The data processing infrastructure 20 in FIG. 2 comprises two processing devices 21-1 and 21-2. Further possible processing devices are indicated by three dots between the processing devices 21-1 and 21-2. Each of the processing devices 21-1 and 21-2 comprises a second network interface 22-1, 22-2, which is designed to connect the processing devices 21-1 and 21-2 to one another. The second network interfaces 22-1, 22-2 can be designed, for example, as wired interfaces 22-1, 22-2, for example as Ethernet interfaces 22-1, 22-2, as fibre-optic interfaces 22-1, 22-2 or as wireless interfaces 22-1, 22-2, for example as WLAN, WIFI, WiMax interfaces 22-1, 22-2 or the like. In one embodiment, the second network interfaces 22-1, 22-2 transfer data using the TCP/IP protocol. In one embodiment, the second network interfaces 22-1, 22-2 transfer data using the same interface and the same protocol as the first network interface 2 of the measuring device 1. In one embodiment, the network interfaces 22-1, 22-2 of the processing devices 21-1, 21-2 are connected via a data network 26.

In one embodiment, the processing devices 21-1 and 21-2 can be in the form of network servers 21-1 and 21-2, for example. In a further embodiment, the individual processing devices 21-1 and 21-2 can each be implemented as server clusters 21-1 and 21-2 respectively, which are connected to one another via a data network 26, for example the Internet 26 or a private backbone network 26. The processing devices 21-1 and 21-2, for example, can each be a computing centre of a company that operates the data processing infrastructure 20.

The data processing infrastructure 20 further comprises a second connection device 23, which during operation connects the processing devices 21-1, 21-2 non-transparently to one another such that they appear to be a single processing device 21-1, 21-2 comprising the data processing functions and the data of all the interconnected processing devices 21-1, 21-2.

The data processing infrastructure 20 further comprises a second control device 25, which can connect the data network 26 of the data processing infrastructure 20 to at least one measuring system 10 via a communications interface 24. The control device 25 is here designed to identify, on connection of the data processing infrastructure 20 to a measuring device 1 of the measuring system 10, the measuring device 1 or the measuring system 10. This can be done using simple identification codes, for example. In one embodiment, the control device 25 is further designed to authenticate the measuring device 1 and/or the measuring system 10, for example using cryptographic techniques.

The second control device 25 can be designed here as a server 25. In one embodiment, the functions of the connection device 23 and of the control device 25 are designed as program modules of an operating software, for example of an operating system, of the processing devices 21-1, 21-2.

In one embodiment, the second connection device 23 is further designed to integrate a measuring system 10 and/or a measuring device 1 into the data processing infrastructure 20, on connection of this measuring system 10 and/or this measuring device 1 to the data processing infrastructure 20, non-transparently as a component thereof, just as for the individual processing devices 21-1, 21-2. In one embodiment, the second control device 25 can further be designed to retrieve measurement data from a measuring device 1 on connection of this measuring device 1 to the data processing infrastructure 20. In a further embodiment, the second control device 25 is designed to retrieve measurement data from this measuring device 1 at regular intervals.

In a further embodiment, the data processing infrastructure 20 comprises a data processing device, which in one embodiment is arranged as a program module in one of the processing devices 21-1, 21-2. The data processing device is designed in this case to provide data processing functions that users 11, for example, can apply to measurement data.

The data processing device is designed as a network server in one embodiment. In particular, the network server can be a network server that has a particularly high processing power in order to perform the data processing functions. In one embodiment, the data processing device can also be designed as a computer cluster.

Possible data processing functions that the data processing device can provide in the data processing infrastructure 20 may be, for example:
calibration
signal linearisation
signal filtering
rotational-speed processing (bridging pulse gaps, double-pulse corrections, . . . )
integration or differentiation (also repeatedly)
various sound-level meter functions
time series analyses
various spectral analyses (FFT, wavelet, digital filter banks, . . . )
operational vibration analysis
beam-forming (sonic ranging)
and more

FIG. 3 is a block diagram of a further embodiment of a data processing infrastructure 20 according to the invention, which is connected to two connected measuring devices 4 via a public data network 30. The measuring systems in FIG. 3 each consist of the connected measuring devices 4. The measuring systems are not shown separately for the sake of clarity.

The data processing infrastructure 20 corresponds to the data processing infrastructure 20 that was described with reference to FIG. 2.

The connected measuring devices 4 in FIG. 3 each comprise two individual measuring devices 1-1, 1-2 and 1-3, 1-4 respectively. The individual measuring devices 1-1, 1-2 and 1-3, 1-4 respectively of the connected measuring devices 4 are connected to each other in each case via a data network and the respective network interfaces 2-1, 2-2 and 2-3, 2-4 respectively.

The measuring devices 1-1 and 1-3 each comprise a first network interface 2-1 and 2-3 respectively, a first control device 5-1 and 5-3 respectively and a sensor interface 7-1 and 7-3 respectively. In the measuring devices 1-1 and 1-3, the function of the connection device 3 is integrated in the control devices 5-1 and 5-3. The sensor interfaces 7-1 and 7-3 are each connected to a sensor 8.

In the embodiments shown in FIG. 3, the sensor interfaces 7-1 and 7-3 are designed as analog sensor interfaces 7-1 and 7-3, which are connected to vibration sensors 8. In further embodiments, different designs of the sensor interfaces 7-1 and 7-3 are possible. For example, one of the sensor interfaces 7-1 and 7-3 can be designed as a digital or optical sensor interface or the like.

Possible sensors 8 that can be connected to the sensor interfaces 7-1 and 7-3 are:
microphones
sensors based on binaural detection technology
acceleration sensors
load cells
strain gauges
rotational-speed sensors
rotary encoders
pressure sensors
temperature sensors
and more

The measuring devices 1-2 and 1-4 each comprise a first network interface 2-2 and 2-4 respectively, a first control device 5-2 and 5-4 respectively and a user interface 6-2 and 6-4 respectively. FIG. 3 also shows two users 11, who each access the user interfaces 6-2 and 6-4 via a computer.

The connected measuring devices 4 and the data processing infrastructure 20 in FIG. 3 are connected to one another via a public data network 30. The public data network 30 can be in the form of the Internet for example. In further embodiments, the public data network 30 can be in the form of a backbone network 30, which is operated by the operator of the data processing infrastructure 20.

In one embodiment, the public data network 30 and the data network 26 can be the same data network 26, 30.

In further embodiments, the number of measuring devices may be larger or smaller than the number of measuring devices 1-1 to 1-4 shown in FIG. 3. In addition, the connected measuring devices 4 may comprise, for example, different numbers of measuring devices 1-1 to 1-4. In further embodiments, the number of measuring devices may also be larger or smaller than the number of measuring devices 4 shown in FIG. 3.

By way of example, a vehicle manufacturer may equip a fleet of cars, for example 20 cars, with one connected measuring device 4 in each case. Each of the connected measuring devices 4 can here comprise, for example, an individual measuring device 1-1 to 1-4 for capturing vibration and acoustic measurement values and an individual measuring device 1-1 to 1-4 for capturing vehicle movements, and a plurality of further individual measuring devices 1-1 to 1-4 arranged in the respective connected measuring device 4.

During such a fleet test, the development engineers may perform during the day, for example, test drives, in which a large amount of measurement data are captured. Once the test drives have been carried out, the development engineers can connect the respective connected measuring devices 4 to a hotel network, for example. Thereupon, the connected measuring devices 4 synchronise the acquired measurement data with the data processing infrastructure 20 of the vehicle manufacturer.

This enables all the development engineers taking part in the fleet test to access and analyse a common database comprising the measurement data from all the vehicles. The present invention also enables, for example, the development engineers that are not taking part in the fleet test to gain advance access to measurement data that was acquired during the fleet test.

The adaption device according to the invention further enables the access of each individual development engineer to the data processing infrastructure 20 to be adapted such that each development engineer can only handle those measurement data that correspond to the field of work of this engineer.

Although the present invention has been described above with reference to preferred embodiments, it is not limited to these embodiments but can be modified in numerous different ways. In particular, the invention can be adapted or modified in various ways without departing from the crux of the invention.

### LIST OF REFERENCE NUMERALS

1, 1-1 to 1-4 measuring device
2, 2-1 to 2-4 network interface
3 connection device
4 connected measuring device
5-1 to 5-4 control device
6-2 to 6-4 user interface
7-1 to 7-3 sensor interface
8 sensor
10 measuring system
11 user
20 data processing infrastructure
21-1, 21-2 processing devices
22-1, 22-2 network interface
23 connection device
24 communications interface
25 control device
26 data network
30 data network

1-18. (canceled)

19. A measuring system for acquiring measurement data in a vehicle, the measuring system comprising:
a measuring device including:
a first network interface designed at least to connect the measuring system to a data processing infrastructure, and
a first connection device designed to connect the measuring system, when a connection to the data processing infrastructure exists, non-transparently to the data processing infrastructure as a component thereof, or to connect the measuring device via the first network interface to a further measuring device non-transparently to form an individual connected measuring device.

20. The measuring system of claim 19, wherein the measuring device further includes a first control device designed to transmit acquired measurement data automatically to the data processing infrastructure when a connection to the data processing infrastructure exists.

21. The measuring system of claim 19, wherein the measuring device further includes a first control device designed to transmit, when a connection to the data processing infrastructure exists, the acquired measurement data to the data processing infrastructure in response to a request from the data processing infrastructure.

22. The measuring system of claim 19, wherein the measuring device further includes a user interface designed to provide access to the measuring device for a user.

23. The measuring system of claim 22, wherein the user interface is designed to provide access for a user to data processing functions of the measuring device, the data processing functions provided to the user constituting at least a subset of a set of data processing functions provided to the user by the data processing infrastructure.

24. The measuring system of claim 22, wherein the user interface is designed to provide, when a connection to the data processing infrastructure exists, access for the user to all the data processing functions that the data processing infrastructure provides to the user.

25. The measuring system of claim 22, wherein the user interface is designed, for those data processing functions that are not provided directly on the measuring device, to transfer the request of the user to the data processing infrastructure, and to receive from the data processing infrastructure the results from the relevant data processing functions and transfer these results to the user.

26. The measuring system of claim 22, wherein the user interface is designed to provide, on connection of the measuring device to at least one further measuring device in the connected measuring device, non-transparent access for a user to all the data processing functions provided by the measuring devices connected in the connected measuring device.

27. The measuring system of claim 19, wherein the measuring device further includes at least one sensor for acquiring respective measurement data and a sensor interface for capturing the measurement data acquired by the sensors.

28. The measuring system of claim 19, wherein the measuring device further includes a first data processing device, which is designed to provide data processing functions for the acquired measurement data.

29. The measuring system of claim 19, wherein the measuring device further includes an adaption device, which is designed to adapt, according to predefined access rights, access to the measuring device.

30. The measuring system of claim 29, wherein the adaption device is designed to adapt, according to the predefined access rights, the function that the measuring device provides as a component of the data processing infrastructure or of the connected measuring device to the data processing infrastructure or to the connected measuring device, respectively.

31. A data processing infrastructure comprising:
at least two processing devices, each of which comprises a second network interface, wherein the second network interface is designed to connect the processing devices to one another;
a second connection device, which is designed to connect the processing devices non-transparently to form a connected processing device;
a communications interface, which is designed to connect the connected processing device to at least one measuring system for acquiring measurement data in a vehicle, comprising a measuring device which comprises: a first network interface, which is designed at least to connect the measuring system to a data processing infrastructure, and a first connection device, which is designed to connect the measuring system, when a connection to the data processing infrastructure exists, non-transparently to the data processing infrastructure as a component thereof; or to connect the measuring device via the first network interface to a further measuring device non-transparently to form an individual connected measuring device; and
a second control device, which is designed to identify or authenticate automatically the measuring system on connection of a measuring system to the data processing infrastructure.

32. The data processing infrastructure of claim 31, wherein the second control device is designed to integrate the measuring system into the data processing infrastructure non-transparently as a component thereof when a connection exists between the data processing infrastructure and a measuring system.

33. The data processing infrastructure of claim 31, wherein the data processing infrastructure is designed to retrieve at specified times measurement data acquired by the measuring system.

34. The data processing infrastructure of claim 31, wherein the data processing infrastructure is designed to retrieve automatically from the respective measuring device on connection of a measuring system to the data processing infrastructure measurement data acquired by the measuring system.

35. The data processing infrastructure of claim 31, wherein the data processing infrastructure comprises at least one second data processing device, which is designed to provide the data processing functions for the acquired measurement data.

36. The data processing infrastructure of claim 31, wherein the data processing infrastructure comprises an adaption device, which is designed to adapt according to predefined access rights access to the data processing infrastructure for a user.
